(19) United States
(12) Patent Application Publication
(10) Pub. No.: US 2011/0270988 A1
(43) Pub. Date: Nov. 3, 2011

(54) COMMUNICATION NETWORK AND NODE THEREOF, METHOD OF CONTROLLING SAID NODE AND COMPUTER-READABLE STORAGE MEDIUM

(75) Inventor: Hirohiko Inohiza, Yokohama-shi (JP)

(73) Assignee: CANON KABUSHIKI KAISHA, Tokyo (JP)

(21) Appl. No.: 13/084,177

(22) Filed: Apr. 11, 2011

(30) Foreign Application Priority Data
Apr. 30, 2010 (JP) 2010-105963

(51) Int. Cl. G06F 15/173

(52) U.S. Cl. 709/226

(57) ABSTRACT

A communication network includes a control node and one or more controlled nodes. The control node transmits allocation information, which indicates a non-conflict region of each node in the communication frame, in a non-conflict region allocated to the control node, if an access request has been received from a new node, allocates a non-conflict region of the new node to the communication frame, and updates the allocation information based upon the allocation. The controlled node relays the allocation information in the non-conflict region of the controlled node if the allocation information has been received, and relays the access request in the non-conflict region of the controlled node if the access request has been received. The new node detects the conflict region and non-conflict region of the communication frame based upon the received allocation information, and transmits, in the detected conflict region, the access request to access the communication network.

### BACKGROUND OF THE INVENTION

1. Field of the Invention

The present invention relates to a communication network and a node thereof, a method of controlling the node and a computer-readable storage medium. More particularly, the invention relates to data transmission technology for allowing a control node to detect a peripheral node and to add the peripheral node to a wireless communication network.

2. Description of the Related Art

In instances where a node that is incapable of directly communicating with a control node is added to a network, the conventional approach is to search for this node via a relay node capable of direct communication with the control node (see the specifications of Japanese Patent Laid-Open Nos. 2008-131517 and 2009-049932). With such an implementation, the control node transmits a peripheral-node search command signal to a relay node that is capable of directly communicating with the control node, and the relay node that has received the search command signal transmits a device search signal to thereby retrieve the peripheral node. The relay node then transmits the result of the node search to the control node. As a result, the control node decides the communication timing allocated to each node and notifies all nodes of communication-region allocation information.

With the conventional implementation, a node capable of directly communicating with either a control node or a relay node capable of direct communication with the control node is detected. This makes it necessary for the user to place the node beforehand at a position where it can communicate directly with the control node or relay node. In particular, in a wireless communication system that utilizes a high frequency such as millimeter waves in the 60-GHz band, it is difficult to assure good communication distance owing to a large amount of transmission attenuation along the communication path. As a consequence, it is difficult to predict the position at which direct communication with a control node or relay node can be achieved.

### SUMMARY OF THE INVENTION

The present invention provides a technique that makes it possible to add to a network a node that cannot directly communicate with either a control node or a relay node capable of directly communicating with a control node.

According to one aspect of the present invention, a communication network in which a plurality of nodes communicate in synchronization with a communication frame having a conflict region and a non-conflict region, includes: a control node; and one or more controlled nodes; wherein the control node includes: a transmitting unit that transmits allocation information, which indicates a non-conflict region of each node in the communication frame, in a non-conflict region that has been allocated to the control node; an allocating unit which, if an access request to access the communication network has been received from a new node that joins the communication network anew, allocates a non-conflict region of the new node to the communication frame; and an updating unit that updates the allocation information based upon the allocation made by the allocating unit; the controlled node includes a relay unit that relays the allocation information in the non-conflict region of the controlled node if the allocation information has been received, and relays the access request in the non-conflict region of the controlled node if the access request has been received; and the new node includes: a detecting unit that detects the conflict region and non-conflict region of the communication frame based upon the allocation information received; and a transmitting unit that transmits, in the conflict region detected by the detecting unit, the access request to access the communication network.

According to another aspect of the present invention, a node of a communication network in which a plurality of nodes communicate in synchronization with a communication frame having a conflict region and a non-conflict region, the node includes: a transmitting unit that transmits allocation information, which indicates a non-conflict region of each node in the communication frame having the conflict region and the non-conflict region, in a non-conflict region that has been allocated to its own node; an allocating unit which, if an access request to access the communication network has been received from a new node that joins the communication network anew, allocates a non-conflict region of the new node to the communication frame; and an updating unit that updates the allocation information based upon the allocation made by the allocating unit.

According to still another aspect of the present invention, a node of a communication network in which a plurality of nodes communicate in synchronization with a communication frame having a conflict region and a non-conflict region, the node includes: a receiving unit that receives the communication frame; and a relay unit which, if allocation information indicating a non-conflict region of each node in the communication frame has been received, relays this allocation information in the non-conflict region of its own node, and if an access request to access the communication network has been received from a new node that joins the communication network anew, relays this access request in the non-conflict region of its own node.

According to yet another aspect of the present invention, a method of controlling a node of a communication network in which a plurality of nodes communicate in synchronization with a communication frame having a conflict region and a non-conflict region, the method includes: a transmitting step of transmitting allocation information, which indicates a non-conflict region of each node in the communication frame having the conflict region and the non-conflict region, in a non-conflict region that has been allocated to its own node; if an access request to access the communication network has been received from a new node that joins the communication network anew, an allocating step of allocating a non-conflict region of the new node to the communication frame; and an updating step of updating the allocation information based upon the allocation made.

According to still yet another aspect of the present invention, a method of controlling a node of a communication network in which a plurality of nodes communicate in synchronization with a communication frame having a conflict region and a non-conflict region, the method includes: a receiving step of receiving the communication frame; and if allocation information indicating a non-conflict region of each node in the communication frame has been received, a relay step of relaying this allocation information in the non-conflict region of its own node, and if an access request to access the communication network has been received from a new node that joins the communication network anew, relaying this access request in the non-conflict region of its own node.

Further features of the present invention will become apparent from the following description of exemplary embodiments (with reference to the attached drawings).

### BRIEF DESCRIPTION OF THE DRAWINGS

FIG. 1 is a diagram representing an example of a network configuration;

FIG. 2 is a block diagram schematically illustrating an example of the configuration of a control node;

FIG. 3 is a block diagram schematically illustrating an example of the configuration of a node;

FIGS. 4A and 4B are diagrams schematically illustrating an example of the structure of a superframe;

FIG. 5 is a diagram illustrating a transition in the structure of a superframe;

FIGS. 6A and 6B are sequence diagrams illustrating overall system flow;

FIG. 7 is a flowchart illustrating a new-node control operation;

FIGS. 8A, 8B and 8C are flowcharts illustrating an existing-node control operation; and

FIG. 9 is a flowchart illustrating a control-node control operation.

### DESCRIPTION OF THE EMBODIMENTS

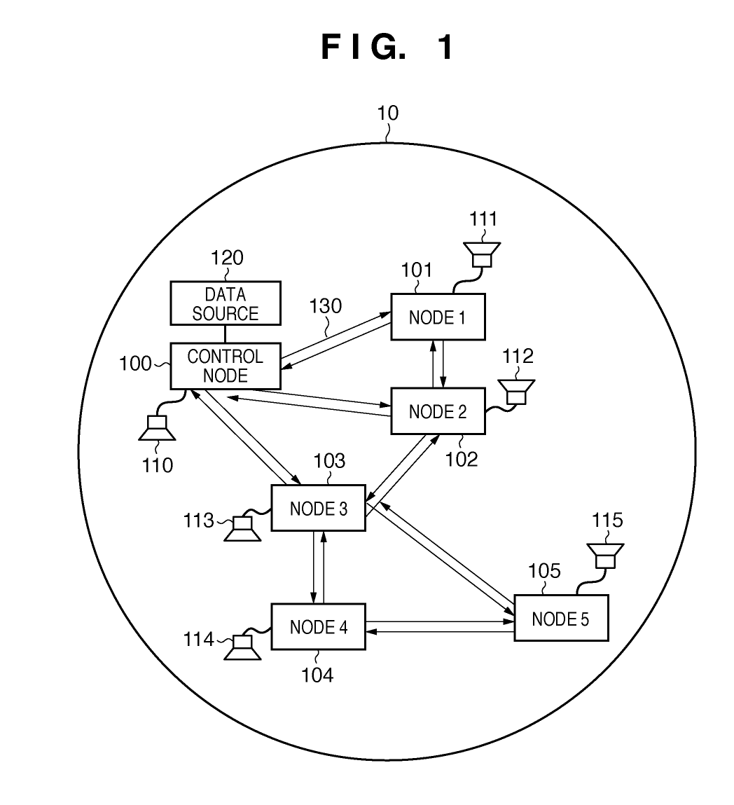

Reference will now be had to FIGS. 1 to 10 to describe the configuration of a network and of each node according to an embodiment of the present invention, the structure of a communication frame, the structure of a packet and node control operations according to the embodiment.

(Network Configuration)

FIG. 1 is a diagram representing an example of the configuration of a network in a wireless communication system according to this embodiment. As illustrated in FIG. 1, the communication network is formed by a plurality nodes. This arrangement is assumed to be that of a 5.1 CH surround system and wirelessly transmits acoustic data from a data source to each of the nodes.

As shown in FIG. 1, a control node 100 controlling the network is connected to a data source 120 that includes acoustic content. It should be noted, however, that the control node 100 need not necessarily be connected to the data source 120 directly.

Speakers 110 to 115 are connected to respective ones of all of the nodes, and acoustic channels (center, front-right, front-left, rear-right, rear-left and subwoofer for base-tone output) used by the respective speakers are decided beforehand. Nodes 1 to 5 (101 to 105) extract data for their own acoustic channels from acoustic data received via acoustic links and output the data to the speakers 111 to 115, respectively. Each of the nodes 100 to 105 has a relay function for relaying and transmitting the received data.

One of the wireless communication links, which is shown at 130, resides within a wireless communication zone 10 of the network. By way of example, data transmitted by the control node 100 is capable of being received by nodes 1 to 3 (101 to 103) but not by nodes 4 and 5 (104 and 105). Similarly, and by way of example, data transmitted by node 1 can be received by the control node 100 and node 2 but not by nodes 3 to 5, and data transmitted by node 4 can be received by nodes 3 and 5 but not by the control node 100 and nodes 1 and 2. It should be noted that the wireless data contains communication-region allocation information necessary for all nodes, control data that includes control commands and access requests, and acoustic data the destinations of which are nodes 1 to 5 (101 to 105), etc. As will be described later, these nodes communicate in synchronization with a prescribed communication frame in the communication network.

The wireless communication system according to this embodiment is such that by having all of the nodes within the network relay and transmit these items of wireless data, a new node can join the network if a connection can be made to any node in the network. Although this embodiment is described taking as an example a case where the type of data sent and received between nodes is acoustic data, it goes without saying that the type of data does not matter in implementing the method of the embodiment.

(Control Node)

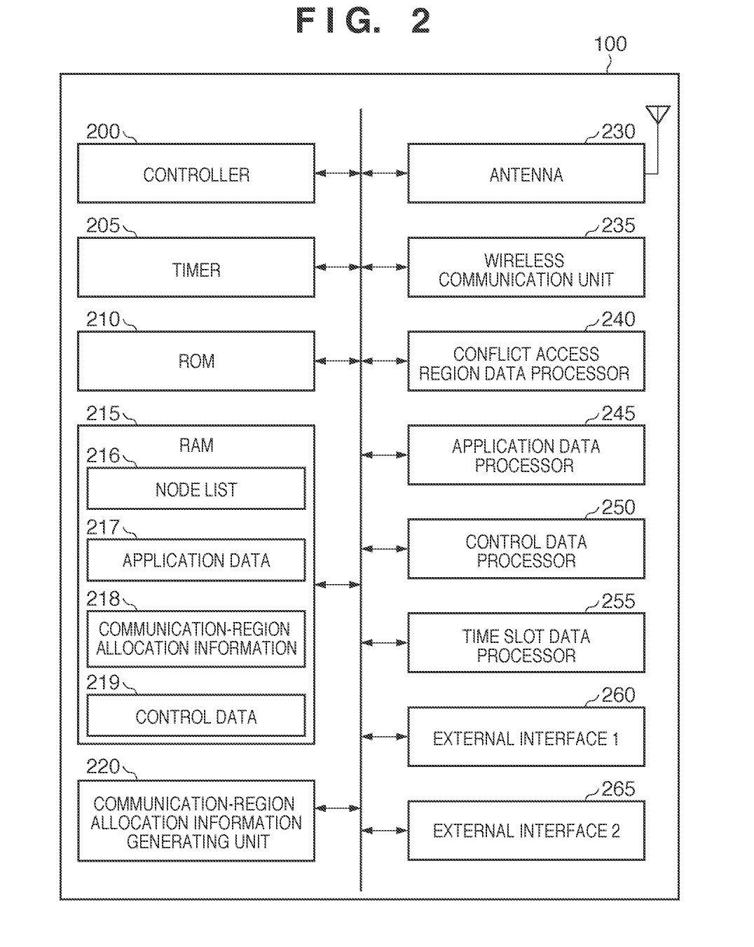

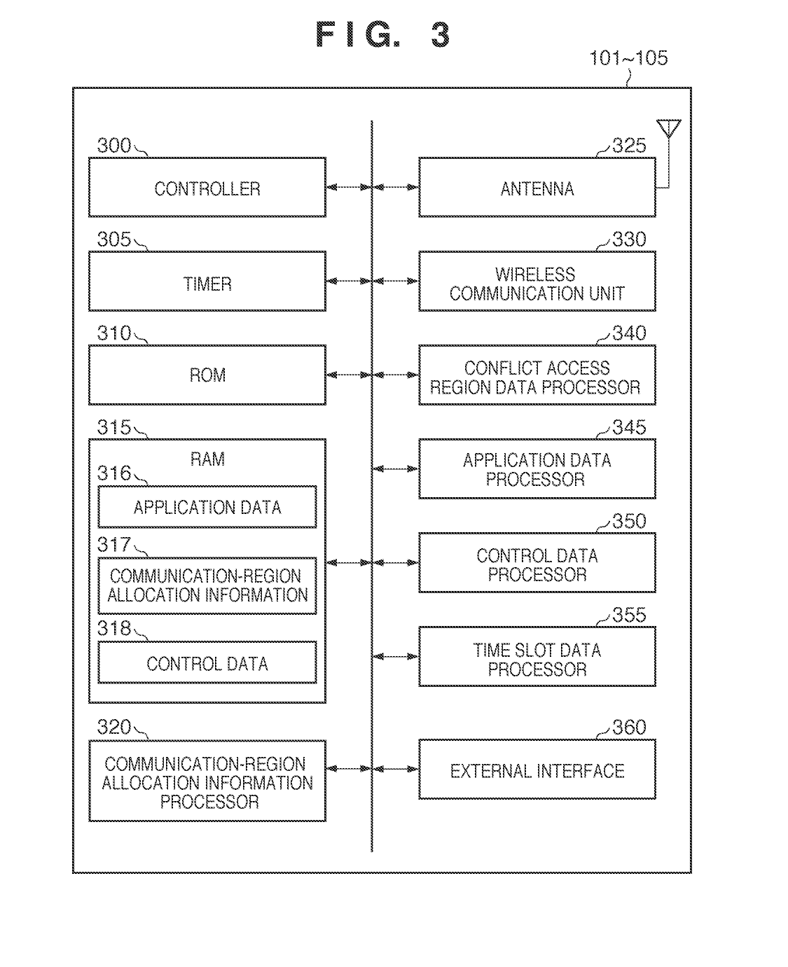

The configuration of each node will be described with reference to FIGS. 2 and 3, in which FIG. 2 is a block diagram illustrating the internal configuration of the control node 100.

A controller 200 controls the overall operation internally of the control node 100. The controller 200 is implemented as by a CPU (central processing unit) or the like. A timer 205 generates the timing of transceive processing. Communication timing such as transceive timing is decided by communication-region allocation information 218. A ROM (read-only memory) 210 is for storing the program of the control node 100 and non-volatile parameters.

A RAM (random-access memory) 215 is for storing volatile parameters and data. A node list 216 indicates a list of existing nodes for which network participation processing has been completed and which have already joined the network. Application data 217 includes acoustic data received from the data source 120. In this example, the assumption is that the application data is acoustic data but this does not impose any limitation; the application data may just as well be data such as video data or simple file data, by way of example. The above-mentioned communication-region allocation information 218 indicates data transceive timing within a communication frame. Control data 219 includes control commands for each of the nodes and an access request, which is data transmitted when a new node joins the network. The items 216 to 219 are all saved in the RAM 215.

A communication-region allocation information generating unit 220 is a block that decides the allocation of a reservation time slot region (a first time domain) and a conflict access region (second time domain) and constructs the communication-region allocation information 218. The control node 100 further includes an antenna 230 for radiating wireless data; a wireless communication unit 235 for executing signal processing for sending and receiving wireless data; a conflict access region data processor 240 for monitoring the conflict access region and checking to determine whether a new node is transmitting an access request; and an application data processor 245 for extracting data used by this node itself from among the application data 217 and outputting this data to an external interface 2 (265).

The control node 100 further includes a control data processor 250 for processing control commands from each of the nodes and an access request of a new node, and a time slot data processor 255 for transmitting time slot data and receiving time slot data from another node at timings decided by the communication-region allocation information 218. The time slot data contains the communication-region allocation information, acoustic data and control data that is generated by each node. The control node 100 further includes external interface 1 (260) for receiving acoustic data from data source 120, and external interface 2 (265) for outputting acoustic data to the speaker 110.

(Ordinary Node)

FIG. 3 is a block diagram illustrating the internal configuration of each of nodes 1 to 5 (101 to 105). A controller 300 controls the overall operation internally of the nodes 1 to 5 (101 to 105). The controller 300 is implemented as by a CPU or the like. A timer 305 generates the timing of transceive processing. Transceive timing is decided by communication-region allocation information 317 received by wireless communication. A ROM (read-only memory) 310 is for storing the programs of nodes 1 to 5 (101 to 105) and non-volatile parameters.

A RAM (random-access memory) 315 is for storing volatile parameters and data. Application data 316 includes acoustic data received by wireless communication. The communication-region allocation information 317 indicates data transceive timing within a communication frame. Control data 318 includes control commands for each of the nodes and an access request of each new node. The items 316 to 318 are all saved in the RAM 315.

A communication-region allocation information processor 320 searches for a received time slot and extracts communication-region allocation information. Each node further includes an antenna 325 for radiating wireless data; a wireless communication unit 330 for executing signal processing for sending and receiving wireless data; a conflict access region data processor 340 for transmitting an access request using a conflict access region in a case where this node is a new node and, in a case where this node is an already existing node, monitoring the conflict access region and checking to determine whether or not to transmit an access request; and an application data processor 345 for extracting data used by this node itself from among the application data 316 and outputting this data to an external interface 360.

Each node further includes a control data processor 350 for processing an access request detected by the conflict access region data processor 340 and processing received control data of another node; and a time slot data processor 355 for transmitting time slot data and receiving time slot data from another node at timings decided by the communication-region allocation information 317. The time slot data contains the communication-region allocation information, acoustic data and control data that is generated by each node. The external interface 360 is for outputting acoustic data to the respective one of the speakers 111 to 115.

(Communication Frame)

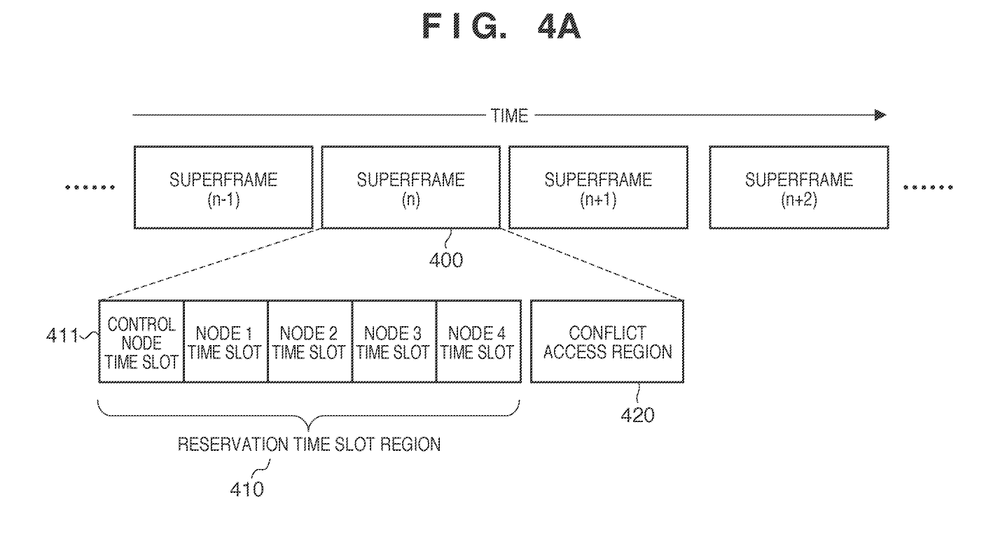

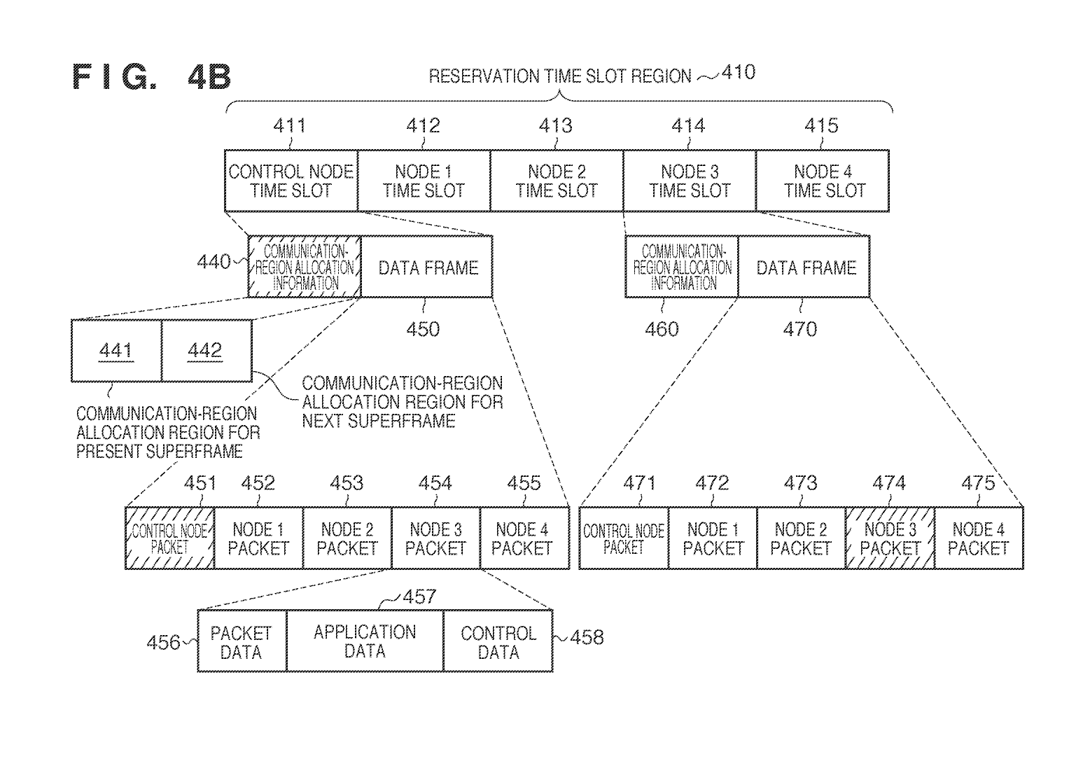

Next, the structure of a communication frame will be described with reference to FIGS. 4A and 4B. FIG. 4A is a diagram illustrating the structure of a superframe 400, which is the communication frame in the wireless communication system of this embodiment. The superframe 400 is of fixed length and is transmitted at a repetition period. The superframe 400 includes two time-share regions, namely a reservation time slot region 410 and a conflict access region 420.

In the reservation time slot region 410, time slots are allocated to a control node and existing nodes (one or more) participating in a network. The reservation time slot region 410 is used in transmitting control data and application data such as acoustic data generated by each node. The conflict access region 420 is used as a common region for all nodes for transmission of an access request when a new node joins the network. An example of a known technique used as a method of transmitting an access request is CSMA/CA, which is a scheme that avoids collision by sensing a carrier at a predetermined time, verifying that another node is not transmitting at such time and then transmitting the data upon elapse of a random period of time. The placement of these two regions within the communication frame and the arrangement of the time slots are stored in their entirety in the communication-region allocation information generated by the control node.

FIG. 4B is a diagram illustrating the structure of the reservation time slot region 410 in greater detail. In this example, time slots 411 to 415 are allocated to respective ones of the control node 100 and already existing nodes 1 to 4 (101 to 104). Each time slot contains communication-region allocation information (440, 460) and a data frame (450, 470).

The time slot 411 is the time slot in which the control node 100 transmits, and it is in this time slot that the communication-region allocation information 440 is generated by the control node 100. The communication-region allocation information 440 includes communication-region allocation information 441 of the current superframe and communication-region allocation information 442 that will by used by the next superframe. The data frame 450 contains relayed data of packets 452 to 455 received from each of the existing nodes and a packet 451 generated by the control node.

Each packet includes a packet header 456, taking packet 454 of node 3 as an example in FIG. 4B. The packet header 456 indicates the arrangement of the data within the packet and is used in order that the control node may monitor whether or not the existing nodes are maintaining synchronization with respect to the superframe. The packet 454 of node 3 contains application data 457, which includes acoustic data, and control data 458.

Similarly, the time slot 414 is the time slot in which node 3 (103) transmits. Specifically, it is in this time slot that the node 3 receives the communication-region allocation information 460 generated by the control node 100 and proceeds to transmit the information in relay fashion.

The data frame 470 contains packets 471 to 473 and packet 475 received from the control node 100 and existing nodes 101, 102, 104, respectively, and a packet 474 generated by node 3. It should be noted that the structures of the packets 472 to 475 are similar to the structure of the packet 454.

Thus, in the time slot region, packets containing communication-region allocation information and control data such as access request are relayed by all of the nodes in the network. As a result, even a node incapable of communicating directly with both a control node and a relay node that can communicate directly with a control node is capable of joining the network if it can be connected to any node in the network.

(Overview of Overall Operation)

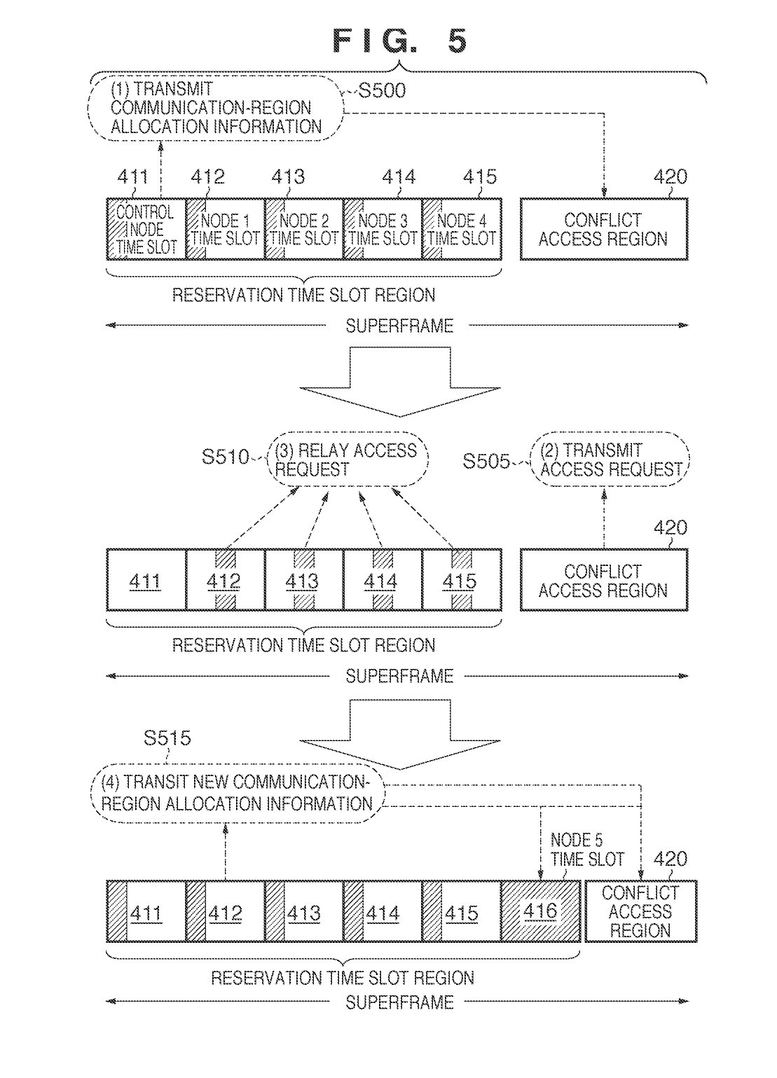

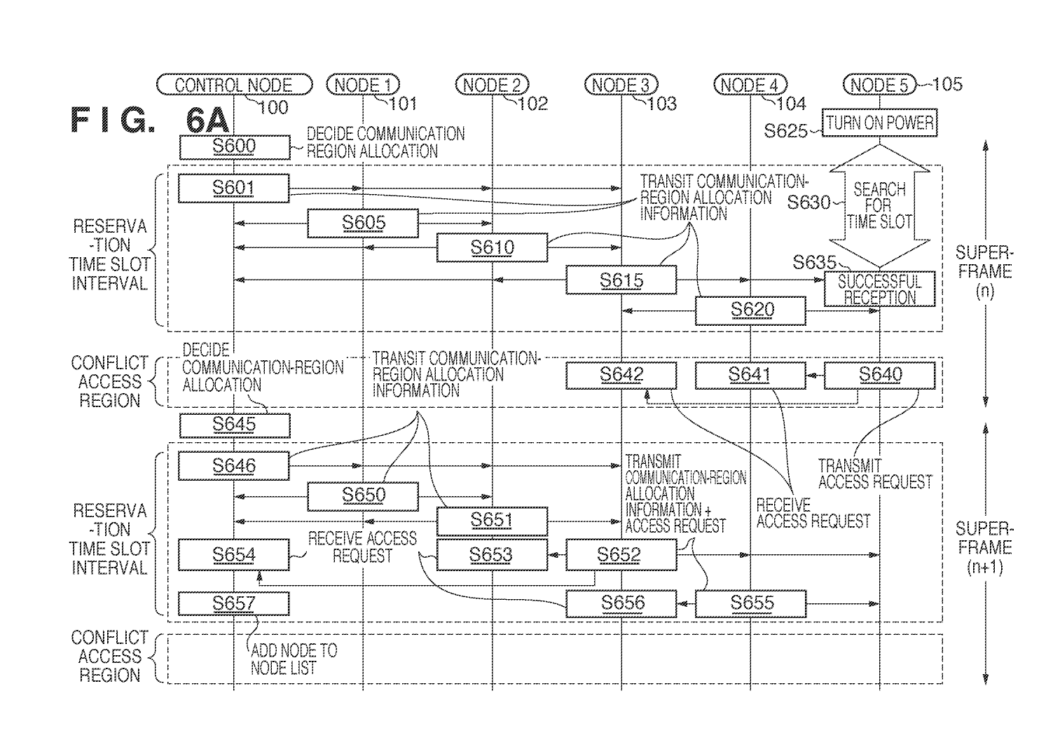

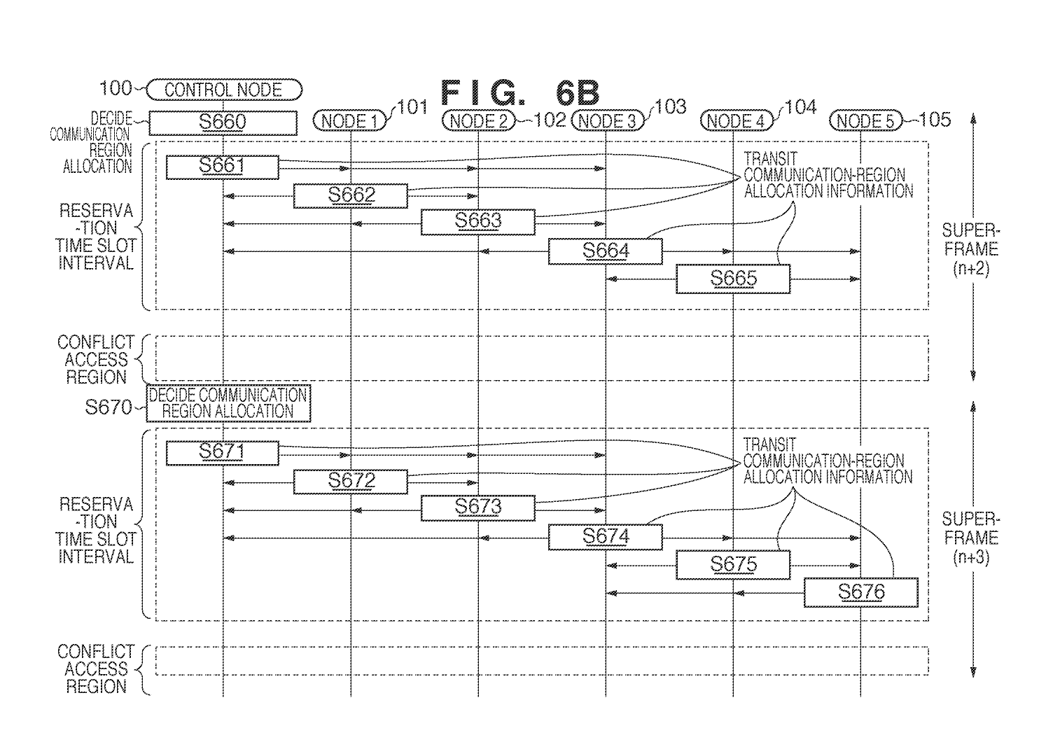

Next, reference will be had to FIG. 5 to describe an overview of overall operation in this embodiment together with a transition in the superframe structure. A more detailed description of overall operation will be rendered later with reference to FIGS. 6A and 6B. In this example, nodes 1 to 4 (101 to 104) are already existing nodes, among which nodes 1 to 3 (101 to 103) are capable of direct communication with the control node 100, whereas node 4 (104) cannot communicate with the control node 100 directly. Operation when node 5 (105) joins the network as a new node will be described below. It should be noted that although node 5 (105) cannot communicate directly with the control node 100 and nodes 1 and 2 (101 and 102), there are cases where it can communicate directly with nodes 3 and 4 (103 and 104).

First, at step S500, using the time slot that has been allocated to it, the control node 100 transmits time slot data that includes the communication-region allocation information generated. Furthermore, using the time slots allocated to them, the existing nodes 1 to 4 (101 to 104) relay the received time slot data containing the communication-region allocation information. In the meantime, node 5 (105) conducts a search of time slots and attempts acquisition of communication-region allocation information. If it succeeds in receiving any one time slot among all of the time slots (411 to 415), then node 5 (105) is capable of acquiring the communication-region allocation information and of identifying the remaining placement of the reservation time slot region and conflict access region.

Next, at step S505, node 5 (105), which could identify placement of the conflict access region, transmits an access request using the conflict access region 420. At step S510 the conflict access region 420 is monitored by the existing nodes 101 to 104 and the access request is relayed to the control node 100 using the time slots 412 to 415 of the respective nodes.

Next, upon receiving the access request from node 5 (105), the control node 100 newly allocates node 5 to the reservation time slot region and shortens the conflict access region attendant upon the increase in size of the reservation time slot region (see FIG. 5). Owing to the fact that the control node 100 transmits the updated communication-region allocation information to all nodes, each node can recognize the fact that node 5 (105) has joined the network anew.

(Overall Operation Sequence)

The flow of overall operation of this embodiment will be described with reference to FIGS. 6A and 6B. Here also in this description of overall operation it will be assumed that, in a manner similar to that of FIG. 5, the nodes 1 to 4 (101 to 104) are already existing nodes and node 5 (105) joins the network as a new node.

Steps S600 to S642 in FIG. 6A indicate processing by each of the nodes in an nth superframe. First, at step S600, the control node 100 decides the allocation of the communication region. Here, in both the nth and (n+1)th superframes, the control node 100 allocates time slots to the existing nodes 1 to 4 (101 to 104) and further allocates the conflict access region. Next, at step S601, using the time slot allocated to it, the control node 100 transmits time slot data containing the communication-region allocation information generated. Further, at steps S605, S610, S615 and S620, using the time slots allocated to them, the existing nodes 1 to 4 (101 to 104) relay the received time slot data containing the communication-region allocation information. The arrows in FIG. 6A indicate the limits of arrival of the transmitted data. For instance, in the example of FIG. 6A, data transmitted from the control node 100 at step S601 reaches nodes 1 to 3 (101 to 103). Similarly, data transmitted from node 1 at step S605 reaches the control node and node 2, and data transmitted from node 2 at step S610 reaches the control node, node 1 and node 3.

Power is introduced to node 5 (105) at step S625. This node then searches for a time slot at step S630 in order to join the network as a new node. In this example, node 5 succeeds at step S635 in receiving the time slot transmitted by node 4 (104) and acquires the communication-region allocation information. Attendant upon such acquisition, node 5 (105) is capable of identifying placement of the conflict access region. Next, at step S640, node 5 (105) transmits an access request using the identified conflict access region. The conflict access region is monitored by the control node and by the existing nodes 101 to 104. In this example, node 4 (104) and node 3 (103) both succeed in receiving the access request from node 5 (105) at step S641 and step S642, respectively.

Next, steps S645 to S657 indicate processing by each of the nodes in the (n+1)th superframe. In this superframe, the control node has not yet recognized the new node. At step S645, therefore, the control node 100 allocates time slots to the existing nodes 1 to 4 (101 to 104) in both the nth and (n+1)th superframes. Next, at step S646, the control node 100 transmits time slot data containing communication-region allocation information. Further, at steps S650 to S652 and step S655, using the time slots allocated to them, the existing nodes 1 to 4 (101 to 104) relay the received time slot data containing the communication-region allocation information. At this time node 3 (103) and node 4 (104) place the access request from node 5 (105) received in the immediately preceding superframe in the time slot data and the relay the data. As a result, the access request relayed by node 3 (103) is received by node 2 (102) at step S653 and by the control node 100 at step S654. Similarly, the access request relayed by node 4 (104) is received by node 3 (103) at step S656. Upon receiving the access request, the control node 100 adds the new node to the network at step S657.

Steps S660 to S665 in FIG. 6B indicate processing by each of the nodes in an (n+2)th superframe. In this superframe the control node 100 recognizes that a new node has been added to the node list. At step S660, the control node 100 allocates time slots to nodes 1 to (101 to 104) in the (n+2)th superframe and to nodes 1 to 5 (101 to 105) in the (n+3)th superframe. The updated communication-region allocation information is relayed by nodes 1 to 4 (101 to 104) at steps S662 to S665. As a result, all nodes can ascertain that node 5 (105) will be added on from the next superframe. Since node 2 (102) and node 3 (103) received the access request of node 5 (105) in the immediately preceding frame, they already know that node 5 (105) has joined the network. Hence, no further relay of the access request is performed.

Next, steps S670 to S676 indicate processing by each of the nodes in the (n+3)th superframe. First, at step S670, the control node 100 allocates time slots to nodes 1 to 5 (101 to 105) in both the (n+3)th superframe and (n+4)th superframe and further allocates the conflict access region. Next, at step S671, using the time slot allocated to it, the control node 100 transmits time slot data containing the communication-region allocation information generated. Further, at steps S672 to S676, using the time slots allocated to them, the existing nodes 1 to 5 (101 to 105) relay the received time slot data containing the communication-region allocation information.

The foregoing is a sequence through which node 5 joins the network anew.

(Operation of New Node)

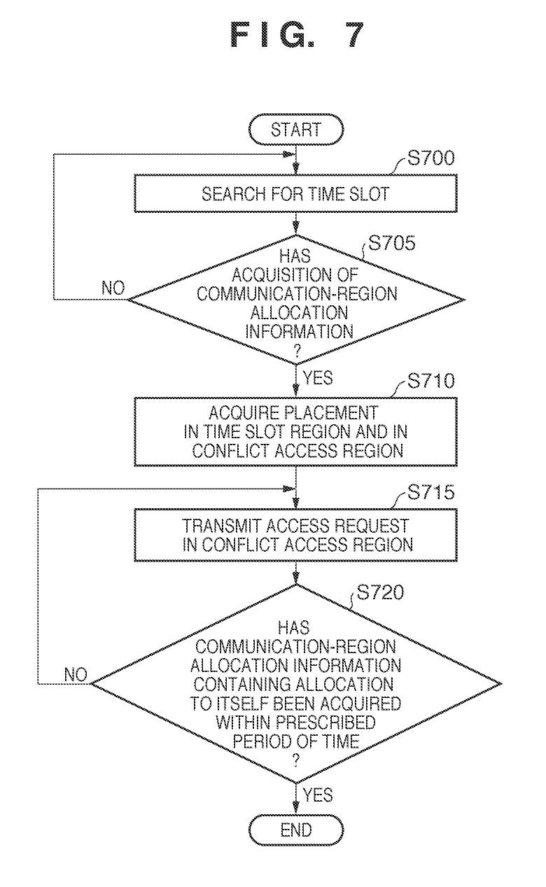

Next, reference will be had to FIGS. 7 to 9 to describe the individual operation of each node.

FIG. 7 illustrates the control operation of a new node. First, at step S700, the new node searches for a time slot within a superframe. At step S705, the new node determines whether acquisition of communication-region allocation information within a time slot has succeeded. If acquisition has succeeded (“YES” at step S705), processing branches to step S710. If acquisition has failed (“NO” at step S705), then processing returns to step S700 and the new node conducts the search again. At step S710, the new node analyzes the communication-region allocation information that it has succeeded in receiving and identifies placement of the time slot within the superframe and placement of the conflict access region. That is, at step S710 the new node discriminates the communication timing that has been decided in the communication frame based upon the communication-region allocation information.

Next, at step S715, and based upon the result of discrimination of communication timing, the new node transmits an access request in the conflict access region that could be identified. It is possible to use a known technique such as the above-mentioned CSMA/CA scheme, for example, as the method of transmitting the access request. Then, at step S720, the new node acquires the communication-region allocation information contained in the time slots transmitted by respective nodes and determines whether communication-region allocation information containing an allocation to itself has been received within a prescribed period of time. If the allocation information contains an allocation to itself (“YES” at step S720), the control node renders a decision to the effect that the new node has been added to the network, processing by the new node ends and processing from this point onward becomes processing by the other nodes. If communication-region allocation information containing an allocation to itself could not be acquired within the prescribed period of time (“NO” at step S720), then control returns to step S715 and the new node transmits the access request again.

(Operation of Existing Nodes)

Superframe Processing

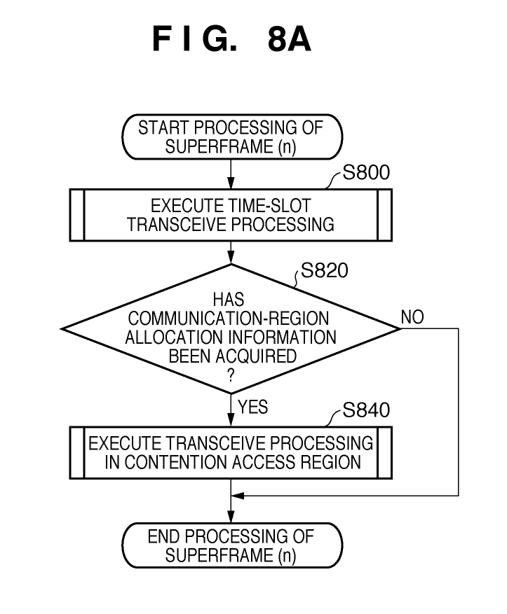

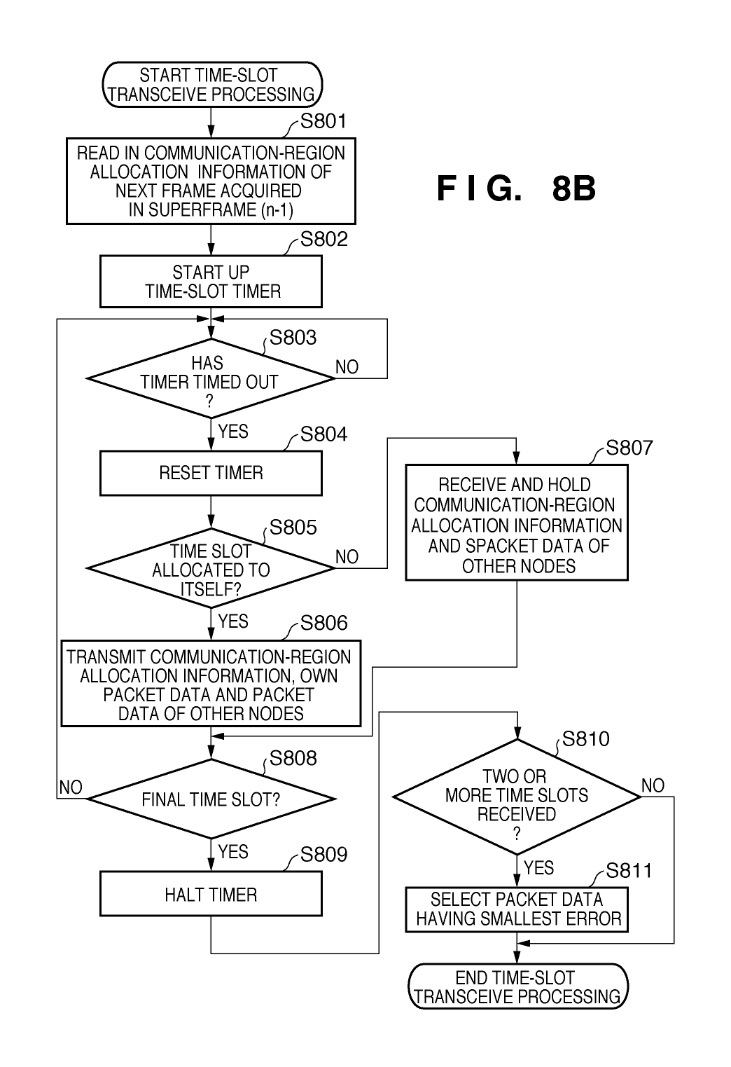

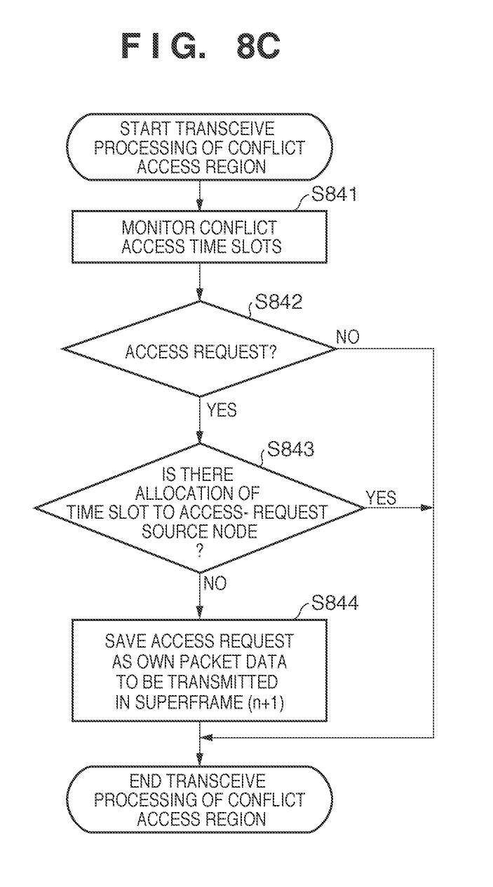

FIGS. 8A, 8B and 8C illustrate the control operation of existing nodes. FIG. 8A illustrates the control operation in an nth superframe. The existing node performs this control operation repeatedly in superframe units. First, at step S800, the existing node executes time-slot transceive processing in the reservation time slot region. The details of this operation will be described later with reference to FIG. 8B. Next, at step S820, the existing node determines whether acquisition of communication-region allocation information succeeded in the time-slot transceive processing of step S800.

If acquisition succeeded (“YES” at step S820), control branches to step S840 where the existing node executes transceive processing in the conflict access region. If acquisition failed (“NO” at step S820), then the existing node exits superframe processing. Transceive processing in the conflict access region will be described later with reference to FIG. 8C.

Time-Slot Transceive Processing

Next, time-slot transceive processing will be described with reference to FIG. 8B. First, at step S801, the existing node reads in an nth item of communication-region allocation information acquired in an (n−1)th superframe. Next, at step S802, the existing node starts up a timer for executing transceive processing on a per-time-slot basis. The timer times out when it has measured the time interval of each time slot that constitutes a predicted time slot. The existing node determines at step S803 whether the timer has timed out. If the timer has not timed out (“NO” at step S803), control returns to step S803. If the timer has timed out (“YES” at step S803), then the flow branches to step S804 where the existing nodes resets the timer.

Next at step S805, and in accordance with the communication-region allocation information read in at step S801, the existing node determines whether the time slot currently processed is a time slot allocated to itself. If the time slot is not one allocated to itself (“NO” at step S805), the flow branches to step S807 where the existing node receives and holds the communication-region allocation information contained in the time slot and packet data that has been generated by each node included in the superframe. If the time slot is one allocated to itself (“YES” at step S805), then the flow branches to step S806 and, using this time slot, the existing node transmits the communication-region allocation information being held, packet data which it itself has generated and packet data generated by each node.

Next, at step S808, the existing node determines whether the time slot currently being processed is the final time slot within the reservation time slot region. If it is determined that the time slot is not the final time slot (“NO” at step S808), control returns to step S803 and the existing node continues time-slot transceive processing. If it is determined that the time slot is the final time slot (“YES” at step S808), then the flow branches to step S809 where the timer of the time slot is halted.

Next, at step S810, the existing node determines whether two or more time slots were received in time-slot receive processing. If two or more time slots could be received (“YES” at step S810), the flow branches to step S811. Here the existing node selects, packet by packet, the packet data that has little error. In making this selection, an error correction encoding technique or the like can be utilized, by way of example. If two or more time slots could not be received (“NO” at step S810), then the packet data that could be received is used as is by the existing node. Next, the flow branches to step S812. If application data of acoustic data is contained in the received packet, then the existing node outputs this to its speaker and reproduces the acoustic at this step.

Conflict Access Region Transceive Processing

Next, conflict access region transceive processing will be described with reference to FIG. 8C. First, at step S841, the existing node monitors the conflict access region specified by communication-region allocation information received as a result of time-slot transceive processing. Then, at step S842, the existing node determines whether an access request transmitted from anew node is included. If an access request is not included (“NO” at step S842), then the existing node terminates the transceive processing of the conflict access region. If an access request is included (“YES” at step S842), then the existing node determines at step S843 whether received communication-region allocation information includes allocation of a time slot of a node that is transmitting the access request. If there is such as allocation (“YES” at step S843), then the existing node is capable of determining that the control node has already received the access request of the new node and completed processing for adding the new node to the network. The existing node therefore terminates transceive processing of the conflict access region without relaying the access request. If there is no allocation (“NO” at step S843), then, in order to relay the access request using the next superframe, namely the (n+l)th superframe, the existing node places the access request in the control data within its own packet and holds the data at step S844.

(Operation of Control Node)

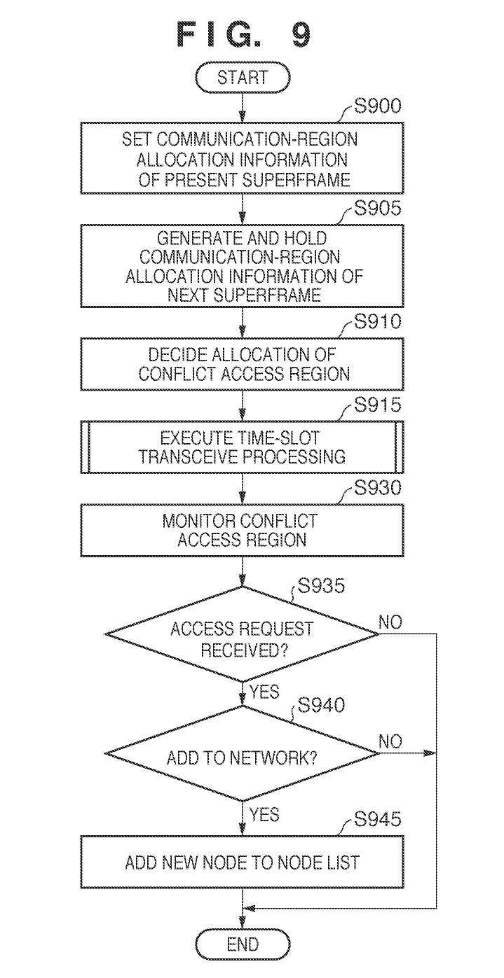

FIG. 9 illustrates the control operation of the control node in an nth superframe. This operation is performed repeatedly in superframe units. First, at step S900, the control node sets the communication-region allocation information of the nth superframe, which was decided at the time of superframe processing of the immediately preceding, or (n−1)th, superframe, as the communication-region allocation information of the present superframe. Next, at step S905, the control node generates the communication-region allocation information of the next superframe based upon the source list, and holds this information. Next, at step S910, the control node decides the allocation of the conflict access region based upon the reservation time slot region decided.

Next, the control node executes time-slot transceive processing at step S915. The details of this processing are similar to those of the time-slot transceive processing of an existing node in FIG. 8B and need not be described again.

At step S930, the control node 100 monitors the conflict access region and, if it includes an access request from a new node, receives the access request. Next, at step S935, the control node determines whether an access request has been received in time-slot transceive processing or transceive processing of the conflict access region. If an access request has been received (“YES” at step S935), the flow branches to step S940; otherwise (“NO” at step S935), the control node terminates the processing of the superframe. At step S940, the control node determines whether it is permissible to add to the network the node that transmitted the access request. The decision as to whether or not to add the node to the network can be rendered based upon whether or not the node that transmitted the access request conforms to the communication specifications of the network constructed by the control node 100, by way of example. Further, the present system communicates by transmitting a fixed-length superframe at a repetition period. This means that there is a limitation upon the number of nodes that a superframe can accommodate. Accordingly, the control node 100 determines whether this limit on number of nodes is exceeded, determines that the node cannot be added to the network if the limit is exceeded and determines that the node can be added to the network if the limit is not exceeded. If the control node determines that it is permissible to add on the node (“YES” at step S940), then the control node adds the node to the node list at step S945. Otherwise (“NO” at step S940), the control node terminates the processing of the superframe.

In accordance with the arrangement of this embodiment, as described above, all nodes in a network relay to one another the communication-region allocation information generated by a control node as well as an access request generated by a new node. Owing to such an arrangement, if a node is one that can be connected to any node within the network, then the control node can detect this node via existing nodes and can generate communication-region allocation information to which the detected node has been added. As a result, the degree of freedom of node placement can be enhanced in comparison with the prior art, and this makes it possible to improve user convenience.

Thus the present invention provides a technique for making it possible to add to a network a node that cannot directly communicate with either a control node or a relay node capable of directly communicating with a control node.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-105963, filed on Apr. 30, 2010, which is hereby incorporated by reference herein in its entirety.

What is claimed is:

1. A communication network in which a plurality of nodes communicate in synchronization with a communication frame having a conflict region and a non-conflict region, comprising:
a control node; and
one or more controlled nodes;
wherein said control node includes:
a transmitting unit that transmits allocation information, which indicates a non-conflict region of each node in the communication frame, in a non-conflict region that has been allocated to said control node;
an allocating unit which, if an access request to access the communication network has been received from a new node that joins the communication network anew, allocates a non-conflict region of the new node to the communication frame; and
an updating unit that updates the allocation information based upon the allocation made by said allocating unit;
said controlled node includes a relay unit that relays the allocation information in the non-conflict region of said controlled node if the allocation information has been received, and relays the access request in the non-conflict region of said controlled node if the access request has been received; and
the new node includes:
a detecting unit that detects the conflict region and non-conflict region of the communication frame based upon the allocation information received; and
a transmitting unit that transmits, in the conflict region detected by said detecting unit, the access request to access the communication network.

2. The communication network according to claim 1, wherein said allocating unit allocates the conflict region of the communication frame to the non-conflict region of the new node.

3. The communication network according to claim 1, wherein data destined for a plurality of controlled nodes is communicated in the non-conflict region that has been assigned to said controlled nodes.

4. The communication network according to claim 3, wherein said relay unit relays data that includes received data destined for another controlled node.

5. The communication network according to claim 1, wherein said allocating unit allocates the non-conflict region to the new node in accordance with the number of controlled nodes.

6. The communication network according to claim 1, wherein the communication frame is of fixed length and said allocating unit allocates the non-conflict region to the new node in accordance with the number of controlled nodes and the length of the communication frame.

7. A node of a communication network in which a plurality of nodes communicate in synchronization with a communication frame having a conflict region and a non-conflict region, said node comprising:
a transmitting unit that transmits allocation information, which indicates a non-conflict region of each node in the communication frame having the conflict region and the non-conflict region, in a non-conflict region that has been allocated to its own node;
an allocating unit which, if an access request to access the communication network has been received from a new node that joins the communication network anew, allocates a non-conflict region of the new node to the communication frame; and
an updating unit that updates the allocation information based upon the allocation made by said allocating unit.

8. The node according to claim 7, wherein said allocating unit allocates the conflict region of the communication frame to the non-conflict region of the new node.

9. The node according to claim 7, wherein data destined for a plurality of controlled nodes is communicated in the non-conflict region that has been assigned to each of the nodes.

10. The node according to claim 7, wherein said allocating unit allocates the non-conflict region to the new node in accordance with the number of nodes.

11. The communication network according to claim 7, wherein the communication frame is of fixed length and said allocating unit allocates the non-conflict region to the new node in accordance with the number of nodes and the length of the communication frame.

12. A node of a communication network in which a plurality of nodes communicate in synchronization with a communication frame having a conflict region and a non-conflict region, said node comprising:
a receiving unit that receives the communication frame; and
a relay unit which, if allocation information indicating a non-conflict region of each node in the communication frame has been received, relays this allocation information in the non-conflict region of its own node, and if an access request to access the communication network has been received from a new node that joins the communication network anew, relays this access request in the non-conflict region of its own node.

13. The node according to claim 12, wherein in a case where said relay unit relays the access request, said relay unit relays the access request together with the allocation information.

14. A method of controlling a node of a communication network in which a plurality of nodes communicate in synchronization with a communication frame having a conflict region and a non-conflict region, said method comprising:
a transmitting step of transmitting allocation information, which indicates a non-conflict region of each node in the communication frame having the conflict region and the non-conflict region, in a non-conflict region that has been allocated to its own node;
if an access request to access the communication network has been received from a new node that joins the communication network anew, an allocating step of allocating a non-conflict region of the new node to the communication frame; and
an updating step of updating the allocation information based upon the allocation made.

15. A method of controlling a node of a communication network in which a plurality of nodes communicate in synchronization with a communication frame having a conflict region and a non-conflict region, said method comprising:
a receiving step of receiving the communication frame; and
if allocation information indicating a non-conflict region of each node in the communication frame has been received, a relay step of relaying this allocation information in the non-conflict region of its own node, and if an access request to access the communication network has been received from a new node that joins the communication network anew, relaying this access request in the non-conflict region of its own node.

16. A computer-readable storage medium storing a computer program for causing a computer to execute the method set forth in claim 14.

17. A computer-readable storage medium storing a computer program for causing a computer to operate as the node set forth in claim 15.
